(19) United States
(12) Patent Application Publication
(10) Pub. No.: US 2004/0186702 A1
(43) Pub. Date: Sep. 23, 2004

(54) Mounting process simulation program and method for the same and system implementing the same

(75) Inventors: Masaki Okamoto, Osaka (JP); Hiroaki Fujiwara, Osaka (JP); Hiroyuki Inoue, Kyoto (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/767,658

(22) Filed: Jan. 29, 2004

(30) Foreign Application Priority Data
Jan. 30, 2003 (JP) P.2003-022698

(51) Int. Cl. G06F 17/50

(52) U.S. Cl. 703/14

(57) ABSTRACT

A focusing portion of a mounting process simulation system selects necessary data, and a result table forming portion forms a result table by using the data and stores the table in a result table storing portion. A condition setting portion forms a condition table based on process condition data input from an input device and stores the table in a condition table storing portion. A sample calculating portion calculates calculated result data by using the result table and the condition table. The condition table storing portion lists the calculated result data on the condition table, and outputs the data to the sample calculating portion as the calculated result data in the pre-step.

The present application is based on Japanese Patent Application No. 2003-022698, which is incorporated herein by reference.

### BACKGROUND OF THE INVENTION

1. Field of the Invention

The present invention relates to a mounting process simulation program executed by a computer to execute a simulation of a mounting process composed of a plurality of steps and a method for the same and a system implementing the same and, more particularly, a mounting process simulation program executed by a computer to simulate successively a plurality of steps and a method for the same and a system implementing the same.

2. Description of the Related Art

In the conventional art, the simulation of the manufacturing process of mounting various electronic parts on the circuit substrate is done individually by analyzing respective steps by virtue of CAE (Computer Aided Engineering) tools or executing experimentally the actual production. For example, in some cases the above mounting is executed by using the reflow soldering process. This reflow soldering process is composed of the solder printing step of printing the solder on electrode portions, which are used to connect electrically the mounted electronic parts, of the circuit substrate on which predetermined circuit patterns are formed, the parts mounting step of arranging the electronic parts such that electrodes of the electronic parts are positioned on printed solders, and the reflowing step of adhering the electronic parts to the substrate by melting the printed solders. Normally respective steps are applied successively to the processed circuit substrate. In case such reflow soldering process is simulated, the simulation is applied to respective steps.

In the reflowing step, the circuit substrate and the electronic parts must be heated to melt the solder. Therefore, the simulation of analyzing the thermal heating method or the heating condition calculating method in such heating is done (For example, see Unexamined Japanese Patent Publication No. 2002-232131). In this simulation, temperature changes of the circuit substrate and the electronic parts during the heating are analyzed based on conditions such as physical property values of the circuit substrate and the electronic parts, which are to be heated, and the temperature setting of the reflow furnace. The temperature setting of the reflow furnace can be verified by comparing the temperature changes of the circuit substrate and the electronic parts with target temperatures by using the results.

Meanwhile, in the above simulation in the mounting process, behavior analysis of the final step and reliability evaluation of the completed circuit substrate are requested, and also final positional analysis of the electronic parts with respect to the circuit substrate is of importance. However, in the simulation of analyzing the thermal heating method or the heating condition calculating method in the above heating, the temperature of the reflow furnace is analyzed and therefore the positional analysis of the electronic parts in the reflowing step cannot be carried out.

Also, as shown in FIG. 13, each step in the mounting process can be simulated individually. For example, in case each step is analyzed by using CAE tools 101a to 101c based on condition DBs (databases) 102a to 102c in which production conditions of each step are stored respectively, simulation results 103a to 103c are derived respectively. According to such analyzing method, the simulation results 103a to 103c of respective steps are independently analyzed respectively, and standard models (e.g., a median and upper/lower limits of the evaluation criterion of the pre-step) are employed as production conditions, etc. of the pre-step. In other words, in case the final positional analysis of the electronic parts with respect to the circuit substrate is executed, normally such analysis is carried out by using the standard models without regard to the production conditions in the pre-step such as positional variation, etc. in the intermediate steps (e.g., the solder printing step or the parts mounting step) of the mounting process. For this reason, continuous simulations over respective steps cannot be carried out. Therefore, in the situation that production variation and changes in production conditions in respective steps act compositely, it is difficult to predict beforehand how behaviors in the final step and the completed circuit substrate are influenced as a consequence. That is, the production conditions in each step can be detected partial-optimally every step, nevertheless it is difficult to detect the optimum conditions throughout the full mounting process.

### SUMMARY OF THE INVENTION

Therefore, it is an object of the present invention to provide a mounting process simulation program of causing a computer to simulate successively respective steps constituting a mounting process by analyzing in advance degrees of influences of initial design conditions and production conditions in respective steps constituting the mounting process upon the overall mounting process and a method for the same, and a system implementing the same.

In order to attain the above object, the present invention possesses features described in the following.

A mounting process simulation program of the present invention causes a computer to execute a simulation of a mounting process composed of a plurality of steps. The mounting process simulation program causes the computer to execute first and second simulation executing steps and a simulation condition deciding step. The first simulation executing step executes a simulation based on a first condition selected for a first step. The simulation condition deciding step decides a result simulated in the first simulation executing step as a simulation condition for a second step positioned subsequent to the first step. The second simulation executing step executes a simulation of the second step based on a second condition containing at least the simulation condition.

According to the above configuration of the present invention, results obtained by simulating respective steps constituting the mounting operation successively can be derived by executing the simulation of the post-step using the simulation result of the pre-step. Therefore, it is possible to check in advance how the overall mounting process is influenced by the initial design conditions and the production conditions in respective steps, and therefore appropriate design of the circuit substrate and appropriate development of the engineering method can be implemented.

The analysis result data being simulated previously based on a plurality of conditions every step may be generated. In this case, as an example, the second simulation executing step executes the simulation of the second step by sampling the analysis result data simulated based on the second condition. Accordingly, the result obtained by executing the simulation of respective steps constituting the mounting process successively by using the analysis result data being simulated previously can be derived. As another example, the second simulation executing step executes the simulation of the second step by executing an interpolation calculation using the analysis result data simulated based on a preceding or succeeding condition of the second condition. Accordingly, if no analysis result data simulated based on the conditions that coincides with the second condition is present, the appropriate simulation can be carried out by using the previously-analyzed analysis result data.

Also, the analysis result data may be generated by other device provided to an outside of the computer. In this case, the second simulation executing step executes the simulation of the second step by converting the analysis result data generated by other device into a predetermined data format. As a first example, the analysis result data are data being simulated previously every step by using a CAE tool. As a second example, the analysis result data are mounting resultant data of a mounting equipment provided to a mounting site every step. As a third example, the analysis result data are experimental data derived by an experiment in which an operation in each step is supposed. Even if the analysis result data simulated by other system have any configuration, the simulation can be carried out by converting such configuration into the common format to use various analysis results by the external system such as detailed analysis results by the CAE tools, the mounting resultant data in the actual mounting equipment, the experimental data derived by an experiment in which an operation in each step is supposed, etc.

Also, the computer may be caused to execute an animation displaying step. The animation displaying step displays three-dimensionally an animation to indicate a result simulated in the second simulation executing step on a display device, by reading previously-stored animation elements based on a definition file in which an operation sequence is defined every step. Accordingly, since the user can visually monitor the simulation result of the second step displayed as the animation, such user can check the simulation result visually with the eye. Also, since the animation is displayed three-dimensionally, the user can visually monitor the more real simulation result. In addition, the animation displaying step can display readily the animation including operations in steps and thus can deal easily with the animated presentation of operations in a new step.

Also, the second simulation executing step may include a condition acquiring step. The condition acquiring step reads a condition being selected in response to an input from a condition database in which a plurality of conditions are stored previously in combination, and adds the condition to the second condition. In addition, the condition acquiring step may read data from a CAD system in response to the input and add the data to the second condition. According to the above, the new condition can be added to the second condition by the instruction in response to the input. Also, when a number of simulation conditions must be input, such conditions can be supplemented by using the data of the condition database or the CAD system and therefore the load of the input operation on the user can be widely reduced.

Various examples described in the following may be considered as examples using the simulation results in the first and/or second simulation executing steps. In the first example, the first simulation executing step executes the simulation to contain production variation in the first step. In this case, the simulation condition deciding step decides the result simulated in the first simulation executing step to contain the production variation as the simulation condition. Then, the second simulation executing step executes the simulation of the second step based on the second condition to contain the production variation. Accordingly, the simulation of the second step in the post-step can be carried out to reflect production variation in the first step, so that the more real simulation can be implemented. In the second example, the first simulation executing step executes the simulation based on a change of a control item set in the first step as the first condition. In this case, the simulation condition deciding step decides the result simulated based on the change of the control item in the first simulation executing step as the simulation condition. Then, the second simulation executing step executes the simulation of the second step based on the second condition to contain the result simulated based on at least the change of the control item. Accordingly, in case the control item set in the first step is changed, a degree of influence on the second step in the post-step can be evaluated. In the third example, the computer is further caused to execute a reliability evaluating step. The reliability evaluating step executes a reliability evaluation of a product manufactured in the mounting process by using the result simulated in the second simulation executing step. Accordingly, influences of the initial design conditions and the production conditions in respective steps on the reliability evaluation of the product can be presumed. In the fourth example, the computer is further caused to execute a fraction defective calculating step. The fraction defective calculating step calculates a fraction defective of a product manufactured in the first step and the second step, by using results simulated in the first simulation executing step and the second simulation executing step. Accordingly, the evaluation criteria of respective steps with respect to the final evaluation criterion of the final product, or the like can be evaluated appropriately in response to the actual production, so that an increase of the yield and a reduction of the fraction defective can be easily attained.

In this case, the present invention can be implemented as a mounting process simulation system having functions of carrying out respective steps that the mounting process simulation program causes the computer to execute. Also, the present invention can be implemented as a mounting process simulation method of executing respective steps that the mounting process simulation program causes the computer to execute.

### BRIEF DESCRIPTION OF THE DRAWINGS

In the accompanying drawings:

FIG. 1 is a view showing hardware configurations of a mounting process simulation system 1 and peripheral equipments according to an embodiment of the present invention;

FIG. 2 is a functional block diagram showing a configuration of the mounting process simulation system 1 in FIG. 1;

FIG. 3 is a flowchart showing an operation of the mounting process simulation system 1 in FIG. 1;

FIG. 4 is an example of a result table of a solder printing step as an object formed in step S3 in FIG. 3;

FIG. 5 is an example of a condition table of the solder printing step as an object formed in step S6 in FIG. 3;

FIG. 6 is a graph explaining an example of a correcting process executed in step S7 in FIG. 3;

FIG. 7 is an example of calculated result data of the solder printing step as an object calculated in step S7 in FIG. 3;

FIG. 8 is an example of a result table of a parts mounting step as an object formed in step S3 in FIG. 3;

FIG. 9 is an example of a condition table of the parts mounting step as an object formed in step S6 in FIG. 3;

FIG. 10 is an example of a result table of a reflowing step as an object formed in step S3 in FIG. 3;

FIG. 11 is an example of a condition table of the reflowing step as an object formed in step S6 in FIG. 3;

FIG. 12 is an example of an animation display that a display device 4 in FIG. 1 displays; and

FIG. 13 is a view explaining a method of simulating individually each step in the mounting process in the conventional art.

### DETAILED DESCRIPTION OF THE PREFERRED EMBODIMENTS

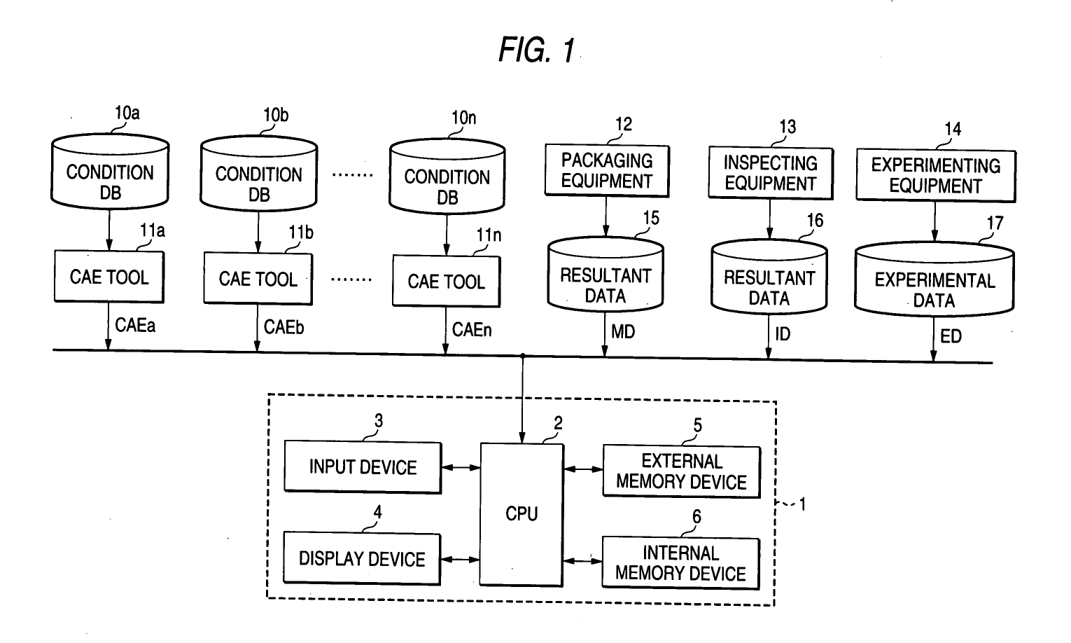

A mounting process simulation system 1 according to an embodiment of the present invention will be explained with reference to FIG. 1 hereinafter. In this case, in the present embodiment, as the simulated mounting process, the reflow soldering process will be explained as an example. This reflow soldering process is composed of the solder printing step of printing the solder on electrode portions, which are used to connect electrically the mounted electronic parts, of the circuit substrate on which predetermined circuit patterns are formed, the parts mounting step of arranging the electronic parts such that electrodes of the electronic parts are positioned on printed solders, and the reflowing step of adhering the electronic parts to the substrate by melting the printed solders. Normally, respective steps are applied successively to the processed circuit substrate.

In FIG. 1, the mounting process simulation system 1 is constructed by a normal computer system, and includes a central processing unit (CPU) 2, an input device 3, a display device 4, an external memory device 5, and an internal memory device 6. The CPU 2 executes predetermined processes by using data acquired from the external device described later, data input by the user via the input device 3, data stored in the external memory device 5, and data stored in the internal memory device 6, and then outputs processed results to the display device 4. The input device 3 is composed of the keyboard, the mouse, or the like. The instruction is input by the user of the mounting process simulation system 1 via the input device 3. The display device 4 is constructed by a display such as a liquid crystal display, CRT, or the like, a printing device, etc. Typically, the processed results of the CPU 2 are displayed or printed by the display device 4. The external memory device 5 is constructed by a large capacity storage medium, etc. of the server, or the like. It is possible that the external memory device 5 may be constructed by a reproducing device such as a hard disk of the computer system, a DVD system, or the like in answer to the stored capacity. The internal memory device 6 is constructed by a memory device such as RAM (Random Access Memory), or the like. The internal memory device 6 may be constructed by the hard disk, or the like in response to the configuration of the external memory device 5.

The data are input into the CPU 2 of the mounting process simulation system 1 from the external device. These data are CAE data CAEa to CAEn analyzed by CAE (Computer Aided Engineering) tools 11a to 11n respectively every simulated step, mounting resultant data MD such as a fraction defective, production results, etc. in each mounting equipment 12 installed in the step and stored in a resultant data storing portion 15, inspection resultant data ID such as a fraction defective, production results, etc. in an inspecting equipment 13, which is installed in the final step, or the like to execute a visual inspection, a conduction test, a performance test, etc., and stored in a resultant data storing portion 16, and experimental data ED collected by executing experimentally the simulated steps by an experimenting equipment 14 respectively and stored in an experimental data storing portion 17. The CAE tools 11a to 11n execute the analysis by using condition databases (DBs) 10a to 10n in which design data being set every simulated step respectively, the production conditions in each step, etc. are stored. Also, an evaluation criterion (e.g., a median and upper/lower limits) set in the pre-process respectively are stored in the condition DBs 10a to 10n. In this case, in case the CAE analysis, the data storage, etc. can be executed in the inside of the mounting process simulation system 1, the CAE analysis is carried out by the mounting process simulation system 1, and then such CAE data CAEa to CAEn, the mounting resultant data MD, the inspection resultant data ID, and the experimental data ED may be stored in the external memory device 5 or the internal memory device 6.

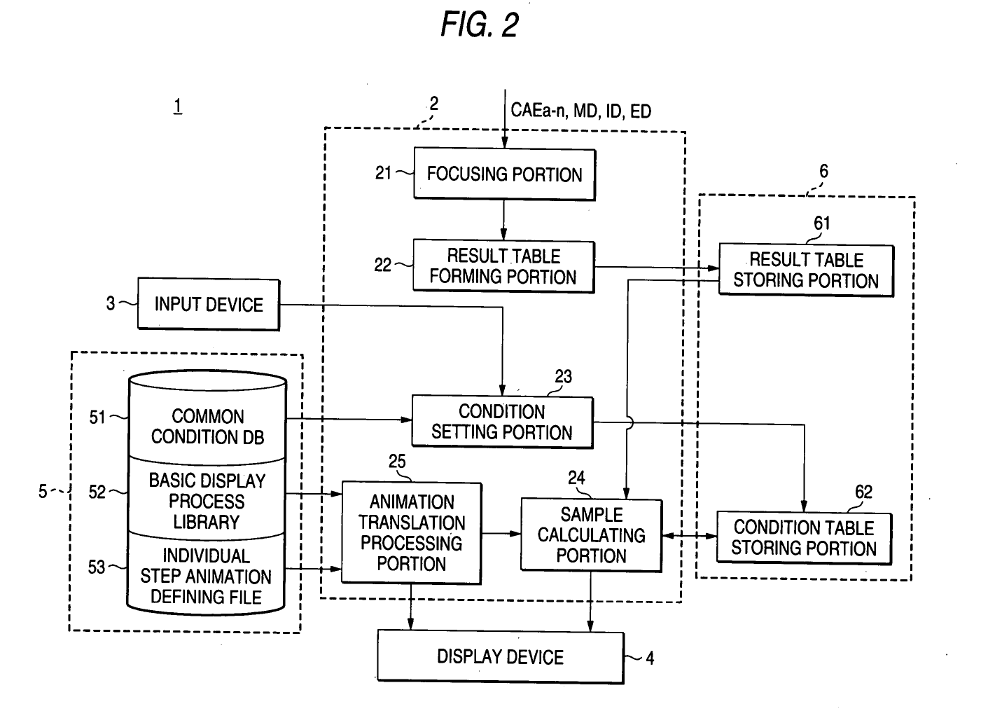

Next, a configuration of the mounting process simulation system 1 will be explained with reference to FIG. 2 hereunder. In this case, FIG. 2 is a functional block diagram showing the configuration of the mounting process simulation system 1.

In FIG. 2, the CPU 2 installed into the mounting process simulation system 1 includes a focusing portion 21, a result table forming portion 22, a condition setting portion 23, a sample calculating portion 24, and an animation translation processing portion 25. The external memory device 5 has a common condition DB 51, a basic display process library 52, and an individual step animation defining file 53. The internal memory device 6 has a result table storing portion 61, and a condition table storing portion 62.

The focusing portion 21 selects data necessary for the process from the data such as the CAE data CAEa to CAEn analyzed by the CAE tool 11a to 11n provided to the outside of the mounting process simulation system 1 respectively, the mounting resultant data MD, the inspection resultant data ID, and the experimental data ED, etc. to run the simulation, and then outputs resultant data to the result table forming portion 22. More particularly, the focusing portion 21 collects the data about the steps as the process object. For instance, in case the focusing portion 21 applies the process to the solder printing step as the object, such focusing portion 21 acquires the data from the CAE tools that apply the CAE analysis to the solder printing process as the object, and acquires the resultant data of the solder printing in the mounting equipment and the experimental data of the solder printing as the object in the experimental equipment. In this case, when data formats of the collected CAE data CAEa to CAEn, the mounting resultant data MD, the inspection resultant data ID, or the experimental data ED are different from format used in the process described later, such formats are converted into a format used in such process (common format) and then output. This common format may be expressed by hierarchical data such as XML, etc. In this manner, the conversion into the common format enables the mounting process simulation system 1 to execute the simulation by using various analysis results by the external devices.

The result table forming portion 22 forms a result table of the steps as the process object by using various data collected by the focusing portion 21, and then stores the result table in the result table storing portion 61. The result table gives discrete data that represent the data collected by the focusing portion 21 in a matrix fashion to correlate with each other in respective items, and condition data and resultant data are shown thereon. For instance, in the case of the data gathered by CAE-analyzing the solder printing step, the result table forming portion 22 forms the result table to correlate the resultant data of the CAE analysis (printed results of a solder size, etc.) with the condition data (solder conditions, printing mask conditions, etc.) used in the CAE analysis respectively. In this case, a particular example of the result table will be described later.

While, the condition setting portion 23 sets the conditions under which the mounting process simulation system 1 executes the simulation process based on the process condition data input by the user via the input device 3, and then forms the condition table. For instance, in the case of the conditions of the solder printing step, the user inputs the production conditions (solder conditions, printing mask conditions, printing device conditions, etc.), etc. of the simulated equipment as the process condition data. Here, if the processed simulation should be executed in detail, the user has to input a large number of process condition data. In order to simplify such inputting operation, the common process condition data and the process condition data that are decided in connection with other data are stored previously in the common condition DB 51, and then the condition setting portion 23 forms the condition table while supplementing the process condition data stored in the common condition DB 51 in response to the input from the user. In this case, with regard to the above common process condition data and the process condition data that are decided in connection with other data, the CAD system (not shown) provided to the outside may generate arrangement data of parts, data of the substrate size, etc. as a part of the process condition data, in addition to the data stored in the common condition DB 51. Also, when the user inputs identifiers indicating respective process condition data, the condition setting portion 23 may read the process condition data corresponding the identifier from the common condition DB 51 or the above CAD system. Then, the condition table formed by the condition setting portion 23 is stored in the condition table storing portion 62. In this case, a particular example of this condition table will be described later.

The sample calculating portion 24 samples calculated result data of the objective step by using the conditions and the result data given in the result table stored in the result table storing portion 61 and the process condition data given in the condition table stored in the condition table storing portion 62. The sample calculating portion 24 samples the result data set forth in the result table corresponding to the process condition data as the calculated result data, based on the process condition data stored in the above condition table. In this case, if no consistent data is found, the sample calculating portion 24 calculates data in vicinity of the result data given in the result table as the calculated result data by executing the interpolation calculation, or the like. Then, the sample calculating portion 24 outputs the calculated result data that are sampled or calculated to the condition table storing portion 62, the animation translation processing portion 25, and the display device 4.

The condition table storing portion 62 stores the condition table output from the condition setting portion 23, and also recites the calculated result data output from the above sample calculating portion 24 on the condition table. Then, the calculated result data given by the sample calculating portion 24 are stored until the simulation process in the next process, and then output to the sample calculating portion 24 as the calculated result data in the pre-step at the time of processing. In other words, the sample calculating portion 24 executes the calculation by using the calculated result data in the pre-step prior to the processed objective step, in addition to the condition data and the result data of the processed objective step given in the result table and the process condition data set by the user's input.

The animation translation processing portion 25 constructs a three-dimensional animation based on the calculated result data output from the sample calculating portion 24, and then outputs the animation to the display device 4. The animation translation processing portion 25 outputs operations in the step as the process object as the animation by using the individual step animation defining file 53, in which operation sequences in the individual steps are defined, based on the data output from the sample calculating portion 24. Individual animation elements constituting the three-dimensional animation such as translation, deformation, etc. of the object are stored in advance in the basic display process library 52. The animation translation processing portion 25 calls appropriately the animation elements stored in the basic display process library 52 based on the individual step animation defining file 53, and constructs the animation corresponding to the calculated result data. Here, in more detail, the animation elements stored in the basic display process library 52 are basic profiles such as the electronic parts, the substrate, the equipment unit, etc. and basic display operations such as translation, deformation, superposition, etc. of the solid, the fluid and the viscous fluid. Also, parameters as the conditions called by the animation translation processing portion 25 are object, translation distance of the object, deformation amount, profiles before and after the deformation, etc. The animation elements are called from the basic display process library 52 based on these parameters. In this manner, the animation translation processing portion 25 can display easily the animation containing the operations in the steps, and can deal easily with the animated presentation of the new step by updating the basic display process library 52 and the individual step animation defining file 53.

The display device 4 displays or prints the animation indicating the calculated result data output from the animation translation processing portion 25, and presents the animation to the user. Also, in case the calculated result data are output directly from the sample calculating portion 24, the display device 4 may display or print the calculated result data as they are as character images such as numerical values, etc.

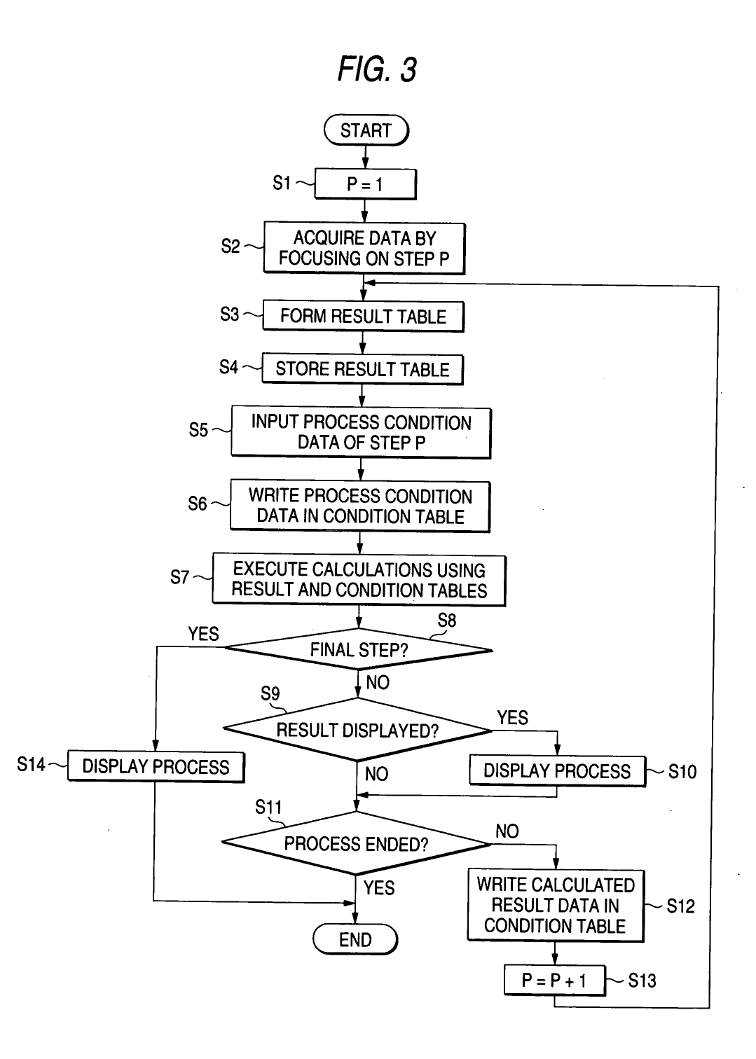

Next, an operation of the mounting process simulation system 1 will be explained with reference to FIG. 3 hereunder. FIG. 3 is a flowchart showing the operation of the mounting process simulation system 1. The operation of the mounting process simulation system 1, described in the following, is carried out by causing the simulation system to execute a mounting process simulation program. This mounting process simulation program is stored in the external memory device 5 and the internal memory device 6, and is carried out in the CPU 2. In this case, the mounting process simulation program may be stored in other memory device except the external memory device 5 and the internal memory device 6 inasmuch as the CPU 2 can read the program to execute.

In FIG. 3, the CPU 2 set a temporary variable P of the processing operation based on the flowchart to 1 (step S1). Then, the CPU 2 advances the process to a next step.

Then, the data of the step P necessary for the process are acquired selectively from the CAE data CAEa to CAEn, the mounting resultant data MD, the inspection resultant data ID, the experimental data ED, etc. by the focusing portion 21 (step S2). For instance, in case the reflow soldering process is to be simulated, the focusing portion 21 acquires the data associated with the step corresponding to the step P among the solder printing step, the parts mounting step, the reflowing step, and the like. Here, since the CAE tools 11a to 11n, the mounting equipment 12 and the experimenting equipment 14 apply the analysis every step respectively, the focusing portion 21 acquires the data from the equipment, which analyzed the step P, as the object by indicating the step P. In this case, as described above, if the data formats of the collected CAE data CAEa to CAEn, the mounting resultant data MD, the inspection resultant data ID, and the experimental data ED are different from the format used in the process, such data formats are converted into the common format upon acquiring.

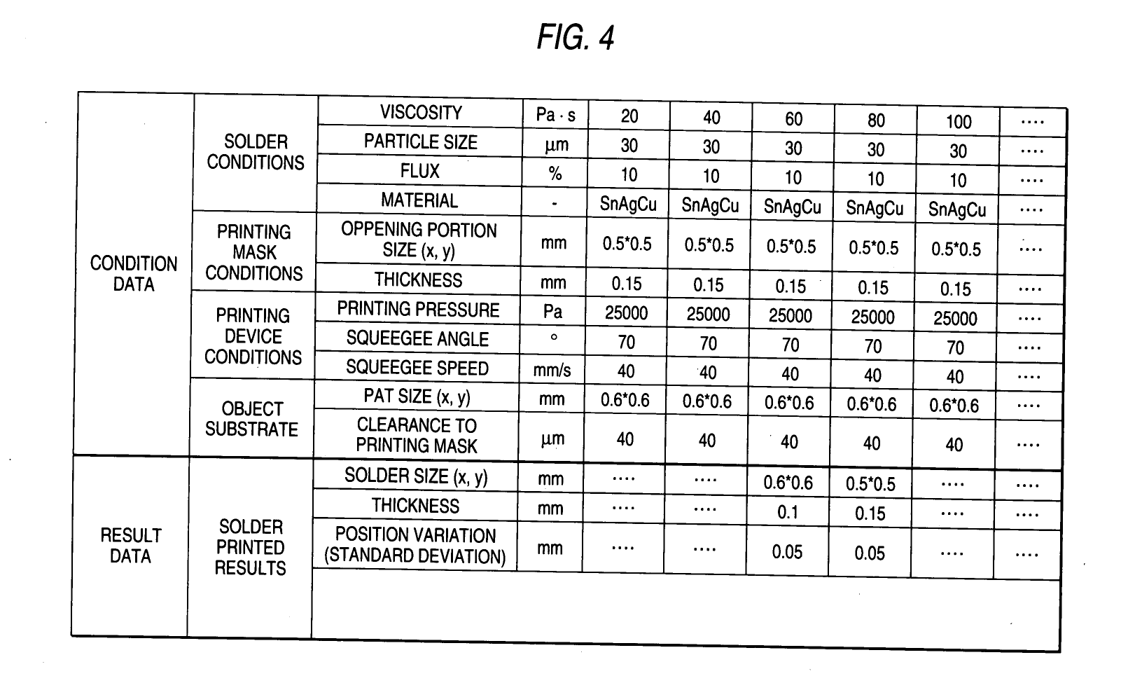

Then, the result table forming portion 22 of the CPU 2 forms the result table by using the data that the focusing portion 21 acquires in step S2 (step S3). An example of the result table formed in step S3 will be explained with reference to FIG. 4 while selecting the above solder printing step as the object hereunder.

The result table is formed by classifying the data into the condition data indicating the analysis conditions used in the analysis by the CAE tools 11 and the experimental data in the experimental equipment 14, etc. and the result data indicating results in the analysis, the experiment, etc. In the case of the above solder printing step as the object, as the above condition data, there are items such as solder conditions (viscosity, particle size, flux, material, etc.), printing mask conditions (opening portion size, thickness, etc.), printing device conditions (printing pressure, squeegee angle, squeegee speed, etc.), the object substrate (pat size, clearance to the printing mask), and so on. Also, the result data are results that are solder-printed based on these condition data, and there are items such as printed results (solder size, thickness, positional variation, etc.), and so on.

The above result table gives the discrete data that are represented in a matrix fashion to correlate with each other in respective items. An example in FIG. 4 shows a part of the result table represented by changing only the viscosity in the solder conditions in the range from 20 Pa·s to 100 Pa·s every 20 Pa·s. For instance, in case the condition data are the solder conditions (viscosity 60 Pa·s, particle size 30 μm, flux 10%, material SnAgCu), the printing mask conditions (opening portion size 0.5 mm*0.5 mm, thickness 0.15 mm), the printing device conditions (printing pressure 25000 Pa, squeegee angle 70°, squeegee speed 40 mm/s), the object substrate (pat size 0.6 mm*0.6 mm, clearance 40 μm to the printing mask), the solder printed results (solder size 0.6 mm*0.6 mm, thickness 0.1 mm, positional variation (standard deviation) 0.05 mm) are represented as the result data to correlate with each other. Also, if the viscosity in the solder conditions of the above condition data is changed into 80 Pa·s but remaining condition data are set commonly, the solder printed results (solder size 0.5 mm*0.5 mm, thickness 0.15 mm, positional variation (standard deviation) 0.05 mm) are represented as the result data to correlate with each other. The result table formed in this manner is output from the CPU 2 to the internal memory device 6, and is stored in the result table storing portion 61 (step S4).

Meanwhile, the user inputs the conditions to be processed in the step P, which is now the process object, as the process condition data via the input device 3 (step S5). The process condition data have items similar to the condition data being set on the above result table. Then, the process condition data are written in the condition table by the condition setting portion 23 of the CPU 2, and then stored in the condition table storing portion 62 of the internal memory device 6 (step S6).

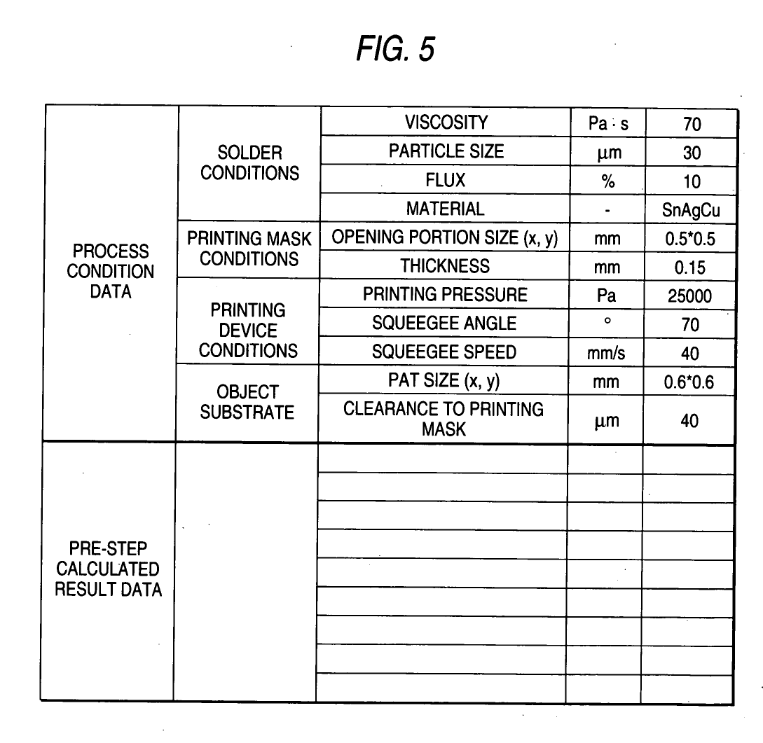

An example of the condition table formed in step S6 will be explained with reference to FIG. 5 while selecting the above solder printing step as the object. The condition table is formed by classifying the data into the process condition data input step S5 and the calculated result data of the pre-step (i.e., the step P-1). In the case of the above solder printing step as the object, there are the items such as solder conditions (viscosity, particle size, flux, material, etc.), printing mask conditions (opening portion size, thickness, etc.), printing device conditions (printing pressure, squeegee angle, squeegee speed, etc.), the object substrate (pat size, clearance to the printing mask, etc.), and so forth as the above process condition data. For instance, the solder conditions (viscosity 70 Pa·s, particle size 30 μm, flux 10%, material SnAgCu), the printing mask conditions (opening portion size 0.5 mm*0.5 mm, thickness 0.15 mm), the printing device conditions (printing pressure 25000 Pa, squeegee angle 70°, squeegee speed 40 mm/s), the object substrate (pat size 0.6 mm*0.6 mm, clearance 40 μm to the printing mask) are written as the process condition data.

In this manner, the user must input a large number of process condition data. In order to simplify such inputting operation, the common process condition data and the process condition data that are decided in connection with other data may be stored previously in the common condition DB 51, and then the condition setting portion 23 may form the condition table while supplementing the process condition data stored in the common condition DB 51 in response to the input from the user. Also, when the user inputs identifiers indicating respective process condition data, the condition setting portion 23 may read the process condition data corresponding the identifier. In this case, the above solder printing step is the top step of the reflow soldering process, no data is written in the calculated result data in the above pre-step.

Then, the sample calculating portion 24 of the CPU 2 executes the simulation operation by using the result table stored in the result table storing portion 61 and the condition table stored in the condition table storing portion 62, and then outputs such calculated result as the calculated result data (step S7). The sample calculating portion 24 samples the result data corresponding to the process condition data and recited in the result table as the calculated result data, based on the process condition data set forth in the condition table. If no consistent data is found, the data in vicinity of the result data given in the result table are calculated as the calculated result data by executing the interpolation calculation, or the like. An example in which the sample calculating portion 24 calculates the calculated result data by executing the interpolation calculation will be described hereunder.

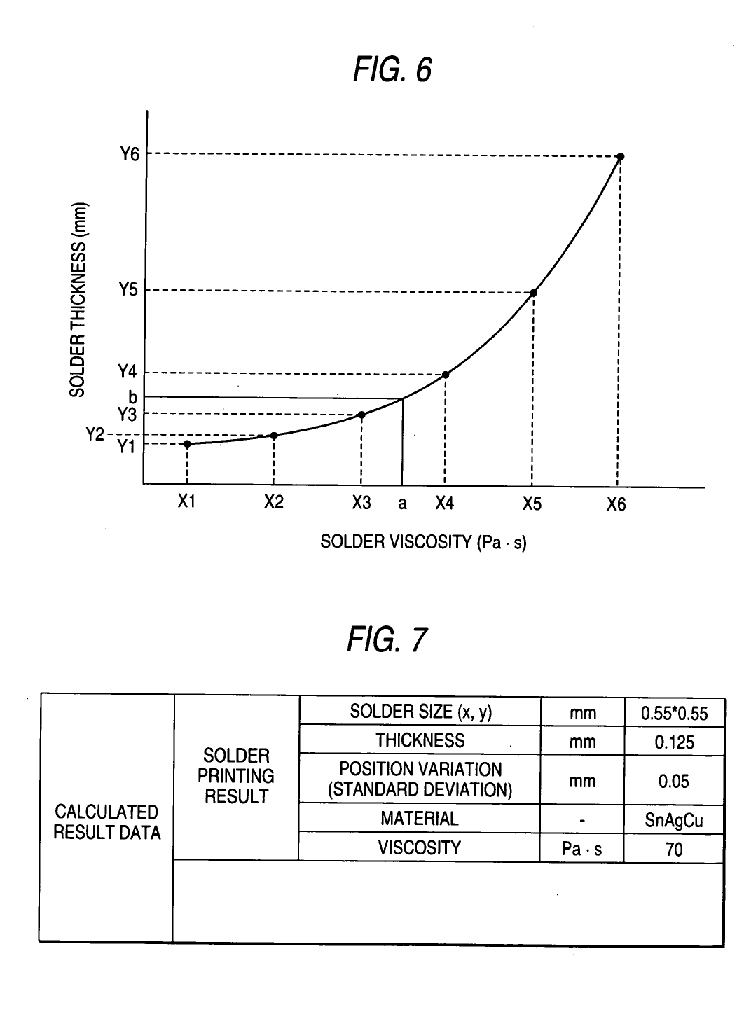

For instance, in case the sample calculating portion 24 calculates the calculated result data by using the result table (see FIG. 4) and the condition table (see FIG. 5) for the above solder printing step, such sample calculating portion 24 calculates the calculated result data by the interpolation calculation since no condition data that coincide with the process condition data in the conditions data is found in the result data. Here, upon comparing the process condition data with the condition data, the inconsistent item is the viscosity in the solder conditions. The sample calculating portion 24 samples the result data obtained under the common condition data except the viscosity, and interpolates respective result data of the viscosity as discrete results by using the spline function (partitioned polynominal), or the like. For instance, in case the solder thickness is calculated as the solder printed result in answer to the process condition data in the condition table shown in FIG. 5 by using the result table shown in FIG. 4, the sample calculating portion 24 extracts the solder thickness data obtained under the common condition data except the viscosity from the concerned result table, and then approximate solder thicknesses Y1 to Y6 with respect to solder viscosities X1 to X6 in terms of the spline function, as shown in FIG. 6. Then, the sample calculating portion 24 generates the interpolation formula of the solder thickness Yn with respect to the solder viscosity Xn, and calculates a solder thickness b with respect to a solder viscosity a by substituting the solder viscosity a indicated by the process condition data into the interpolation formula. The sample calculating portion 24 calculates the calculated result data with respect to the process condition data by applying the similar interpolation calculation to other result data. More concretely, the solder printed results (solder size 0.55 mm*0.55 mm, thickness 0.125 mm, positional variation (standard deviation) 0.05 mm) are calculated as the calculated result data.

Then, another example in which the sample calculating portion 24 calculates the calculated result data by executing the interpolation calculation will be explained hereunder. First, the sample calculating portion 24 samples the condition data (i.e., the viscosity 60 Pa·s and the viscosity 80 Pa·s in the solder conditions but remaining condition data are common) in the neighborhood of the process condition data (i.e., the viscosity 70 Pa·s in the solder conditions) in the inconsistent item. Then, the sample calculating portion 24 executes the interpolation calculation by using the interpolation formula set previously to the inconsistent item, based on respective process condition data in the inconsistent item and the condition data. In the case of the data shown in FIG. 4 and FIG. 5, the solder printing result are calculated as the calculated result data by applying the interpolation calculation to the viscosity 60 Pa·s and the viscosity 80 Pa·s in the solder conditions indicated in the above condition data, by using the interpolation formula set previously to the viscosity 70 Pa·s in the solder conditions in the above process condition data. More concretely, as shown in FIG. 7, the interpolation calculation with respect to the viscosity is applied between the solder printing results (solder size 0.6 mm*0.6 mm, thickness 0.1 mm, positional variation (standard deviation) 0.05 mm) associated with the viscosity 60 Pa·s in the solder conditions of the result table and the solder printing results (solder size 0.5 mm*0.5 mm, thickness 0.15 mm, positional variation (standard deviation) 0.05 mm) associated with the viscosity 80 Pa·s in the solder conditions of the result table. As a result, the solder printing results (solder size 0.55 mm*0.55 mm, thickness 0.125 mm, positional variation (standard deviation) 0.05 mm) are calculated as the calculated result data. That is, in this calculated example, the processing man-hour required for the interpolation calculation can be reduced by setting previously the above interpolation formula. In this manner, in case the mounting process simulation system 1 executes the simulation under the process conditions different from the conditions used previously in the analysis, such system can execute the appropriate simulation by using the previously analysis results.

In addition, the sample calculating portion 24 samples predetermined items (e.g., the viscosity and the material in the solder conditions) required for the calculation of the next step and extracted without the interpolation calculation, as the calculated result data.

Then, the CPU 2 decides whether or not the step P being calculated now is the final step (step S8). For instance, if the CPU 2 simulates the above reflow soldering process, such CPU 2 decides whether or not the step P is the reflowing step as the final step. Then, the CPU 2 advances the process to next step S14 if the step P is the final step, while the CPU 2 advances the process to next step S9 unless the step P is the final step.

Instep S9, the CPU 2 decides whether or not the calculated result data in the step P being calculated now are displayed on the display device 4. Then, the CPU 2 advances the process to next step S10 if the calculated result data are displayed on the display device 4, while the CPU 2 advances the process to next step S11 unless the calculated result data are displayed on the display device 4.

In step S11, the CPU 2 decides whether or not the simulation process being executed now is ended. Then, the CPU 2 ends the process in compliance with the flowchart if the simulation process is ended, while the CPU 2 advances the process to next step S12 if the simulation process is continued.

In step S12, the sample calculating portion 24 of the CPU 2 writes the calculated result data calculated in step S7 into the condition table of the condition table storing portion 62. The calculated result data are written as the calculated result data in the pre-step. For instance, the sample calculating portion 24 writes the calculated result data shown in FIG. 7 into the pre-step calculated result data of the condition table stored in the condition table storing portion 62 and shown in FIG. 5. Then, the CPU 2 advances the process to next step.

Then, the CPU 2 increments the above temporary variable P in the processing operation by +1 in compliance with the flowchart to set a new temporary variable P (step S13). Then, the process goes back to step S2 and the process is continued.

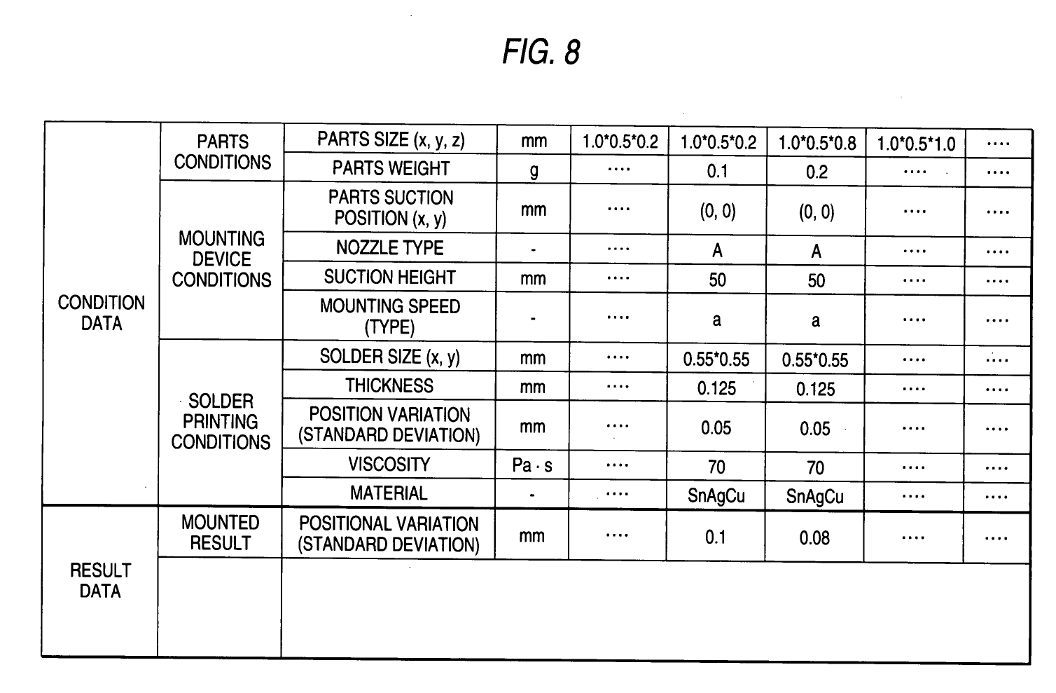

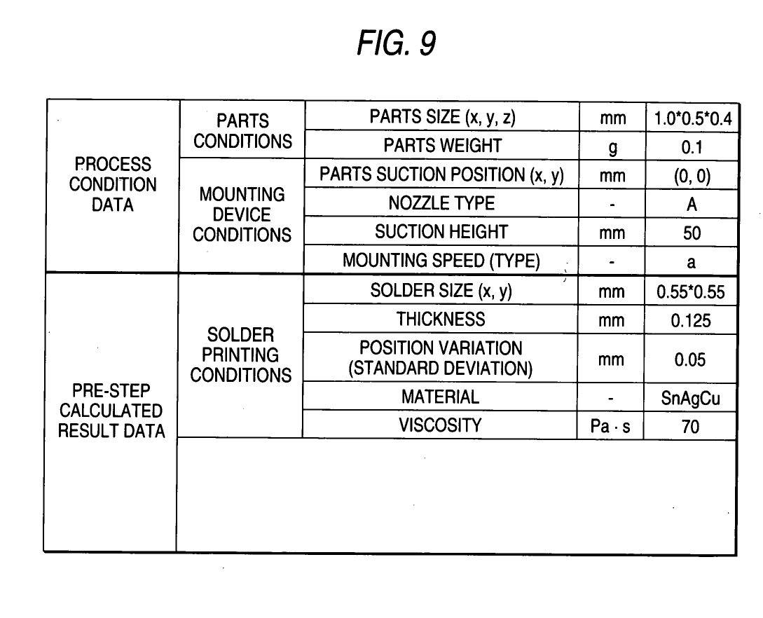

After the new temporary variable P is set in step S13, the CPU 2 executes the simulation in the new step P according to the same processes in above steps S2 to S7. Typically, this new step P is the step subsequent to the step that has already been simulated. In case the solder printing step in the reflow soldering process has already been simulated as described above, the parts mounting step in next step is simulated as the new step P. Then, a data example in which the CPU 2 simulates the parts mounting step in next step as the new step P will be explained with reference to FIG. 8 and FIG. 9 hereunder. In this case, FIG. 8 is an example of the result table formed in the parts mounting step, and FIG. 9 is an example of the condition table formed in the parts mounting step.

In FIG. 8, the result table forming portion 22 of the CPU 2 forms the result table by using the data of the parts mounting step acquired by the focusing portion 21 in step S2. In step S2, similarly the focusing portion 21 acquires the data of the parts mounting step from the CAE data CAEa to CAEn, the mounting resultant data MD, the inspection resultant data ID, the experimental data ED, and so on, but its detailed explanation will be omitted herein because such process is similar to the above process.

The result table of the above parts mounting step is also formed by classifying the data into the condition data indicating the analysis conditions used in the analysis by the CAE tool 11, the experimental conditions of the experimenting equipment 14, etc. and the result data indicating the analysis results, the experimental results, etc. In the case of the parts mounting step as the object, there are the items such as the parts conditions (parts size, parts weight, etc.), the mounting device conditions (parts suction position, nozzle type, suction height, mounting speed, etc.), the solder printing conditions (solder size, thickness, positional variation, viscosity, material, etc.) as the above condition data. Also, the result data are results of mounting the parts based on these condition data, there are the items such as mounted results (positional variation, etc.).

The above result table gives discrete data associated with respective items and represented in a matrix fashion. An example in FIG. 8 shows a part of the result table represented by changing only the parts size in the parts conditions respectively. For instance, in case the condition data are given as the parts conditions (parts size 1.0 mm*0.5 mm*0.4 mm, parts weight 0.1 g), the mounting device conditions (parts suction position (0 mm, 0 mm), nozzle type A, suction height 50 mm, mounting speed (type) a), the solder printing conditions (solder size 0.55 mm*0.55 mm, thickness 0.125 mm, positional variation (standard deviation) 0.05 mm, viscosity 70 Pa·s, material SnAgCu), the result data are represented to correlate with the mounted results (positional variation (standard deviation 0.1 mm)). Also, if the parts size of the parts conditions in the above condition data is changed into 1.0 mm*0.5 mm*0.8 mm but remaining condition data are set commonly, the result data are represented to correlate with the mounted results (positional variation (standard deviation 0.08 mm)). In step S4, the result table formed in this manner is output from the CPU 2 to the internal memory device 6, and is stored in the result table storing portion 61. In this case, the result table of the pre-step (i.e., the solder printing step) has already been stored in the result table storing portion 61, but such result table of the pre-step may be completely erased in step S4.

Meanwhile, in step S5 the condition table in FIG. 9 is formed by inputting the process condition data in connection with the parts mounting step from the user. The process condition data have the same items as the condition data being set in the result table. Then, in step S6, the process condition data are written into the condition table by the condition setting portion 23, and then stored in the condition table storing portion 62 of the internal memory device 6.

The process condition data input in step S5 and the calculated result data of the pre-step (i.e., the step P-1) are written in the condition table of the parts mounting step. As described above, in the simulation process of the solder printing step as the pre-step of the parts mounting step, in step S12, the solder printing results (solder size 0.55 mm*0.55 mm, thickness 0.125 mm, positional variation (standard deviation) 0.05 mm, viscosity 70 Pa·s, material SnAgCu) in the solder printing step have already been written in the condition table as the pre-step calculated result data. Also, there are the items such as the parts conditions (parts size, parts weight, etc.), the mounting device conditions (parts suction position, nozzle type, suction height, mounting speed, etc.) as the process condition data. For instance, the parts conditions (parts size 1.0 mm*0.5 mm*0.4 mm, parts weight 0.1 g), the mounting device conditions (parts suction position (0 mm, 0 mm), nozzle type A, suction height 50 mm, mounting speed (type) a) are newly written as the process condition data. In this case, the processing condition data of the pre-step (i.e., the solder printing step) have already been described in the condition table storing portion 62 and such data may be completely erased in step S4. But it is preferable that such data should be stored continuously to display the conditions used in the simulation in the display process described later.

Then, in step S7, the sample calculating portion 24 of the CPU 2 executes the simulation operation by using the result table (see FIG. 8) and the condition table (see FIG. 9) of the parts mounting step, and outputs the results as the calculated result data. The sample calculating portion 24 samples the result data corresponding to these data and set forth in the condition table as the calculated result data, based on the process condition data set forth in the condition table and the pre-step calculated result data. Since the condition data equivalent to the data set forth in the condition table shown in FIG. 9 are present in the result table shown in FIG. 8, the sample calculating portion 24 samples the result data associated with the condition data as the calculated result data in the parts mounting step. In other words, the sample calculating portion 24 executes the simulation of the parts mounting step containing the simulation process results in the pre-step, and samples the mounted result (positional variation 0.1 mm) as the calculated result data. In addition, the sample calculating portion 24 also samples predetermined items (e.g., the parts size and the parts weight in the parts conditions) necessary for the calculation in next step as the calculated result data. In this case, it is needless to say that, if the data that coincide with the condition table are not contained in the condition data in the result table in the parts mounting step, the sample calculating portion 24 calculates the data in vicinity of the above result data set forth in the result table as the calculated result data by executing the interpolation calculation, or the like.

In step S12, the sample calculating portion 24 of the CPU 2 writes the calculated result data of the parts mounting step calculated in step S7 into the condition table of the condition table storing portion 62. The calculated result data are also written as the pre-step calculated result data in the condition table. For example, the sample calculating portion 24 writes the calculated result data of the parts mounting step into the pre-step calculated result data in the condition table stored in the condition table storing portion 62 and shown in FIG. 9. That is, the calculated result data of the solder printing step and the parts mounting step are written into the pre-step calculated result data in the condition table.

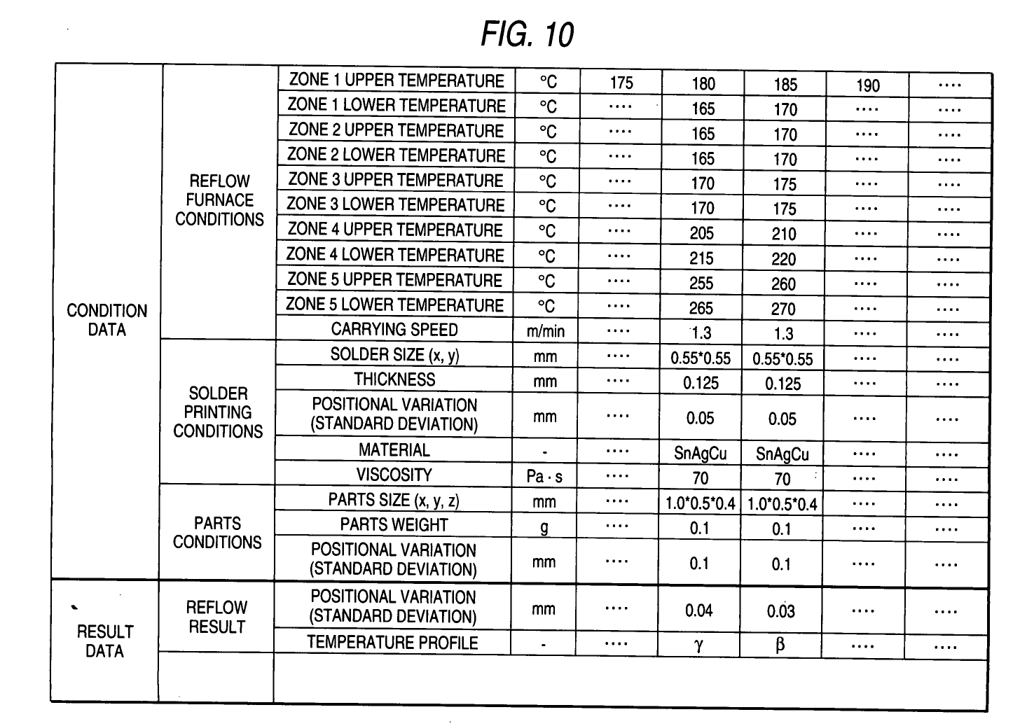

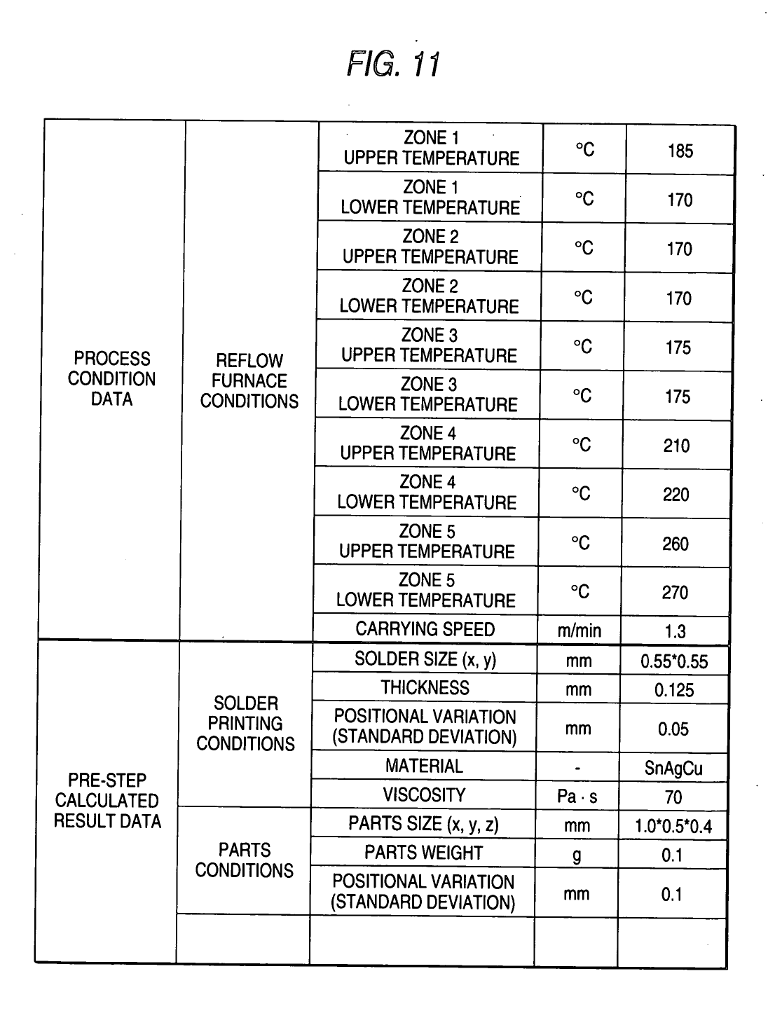

In addition, in case the CPU 2 increments the temporary variable P in the processing operation in compliance with the flowchart by +1 to set the new temporary variable P in step S13, such CPU 2 executes the simulation in the new step P by the same process as those in above steps S2 to S7. Typically the new step P is a step subsequent to the step that has already been simulated. If the parts mounting step in the reflow soldering process has already been simulated as described above, the reflowing step in the next step P is simulated as the new step P. A data example in which the CPU 2 simulates the reflowing step in the next step as the next step P will be explained with reference to FIG. 10 and FIG. 11 hereunder. In this case, FIG. 10 shows an example of the result table formed in the reflowing step, and FIG. 11 shows an example of the condition table formed in the reflowing step.

In FIG. 10, the result table forming portion 22 of the CPU 2 forms the result table by using the data of the reflowing step acquired by the focusing portion 21 in step S2. In step S2, similarly the focusing portion 21 acquires the data of the reflowing step from the CAE data CAEa to CAEn, the mounting resultant data MD, the inspection resultant data ID, the experimental data ED, and so on, but its detailed explanation will be omitted herein because such process is similar to the above process.

The result table of the above reflowing step is also formed by classifying the data into the condition data indicating the analysis conditions used in the analysis by the CAE tool 11, the experimental conditions of the experimenting equipment 14, etc. and the result data indicating the analysis results, the experimental results, etc. In the case of the reflowing step as the object, there are the items such as the reflow furnace conditions (zone temperature, carrying speed, etc.), the solder printing conditions (solder size, thickness, positional variation, viscosity, material, etc.), the parts conditions (parts size, parts weight, positional variation, etc.), and so on as the condition data. Also, the above result data are the reflow results based on these condition data, and there are the items such as the reflow results (positional variation, profile type, etc.), and so on.

The result table gives the discrete data associated with respective items and represented in a matrix fashion. An example in FIG. 10 shows a part of the result table represented by changing only the zone temperature in the reflow furnace conditions respectively. For instance, in case the condition data are given as the the reflow furnace conditions (zone 1 upper temperature 180° C., zone 1 lower temperature 165° C., zone 2 upper temperature 165° C., zone 2 lower temperature 165° C., zone 3 upper temperature 170° C., zone 3 lower temperature 170° C., zone 4 upper temperature 205° C., zone 4 lower temperature 215° C., zone 5 upper temperature 255° C., zone 5 lower temperature 265° C., carrying speed 1.3 m/min), the solder printing conditions (solder size 0.55 mm*0.55 mm, thickness 0.125 mm, positional variation (standard deviation) 0.05 mm, viscosity 70 Pa·s, material SnAgCu), and the parts conditions (parts size 1.0 mm*0.5 mm*0.4 mm, parts weight 0.1 g, positional variation (standard deviation) 0.1 mm), the result data are represented to correlate with the reflow results (positional variation (standard deviation) 0.04 mm, temperature profile γ). Also, in case the reflow furnace conditions in the above condition data are changed into zone 1 upper temperature 185° C., zone 1 lower temperature 170° C., zone 2 upper temperature 170° C., zone 2 lower temperature 170° C., zone 3 upper temperature 175° C., zone 3 lower temperature 175° C., zone 4 upper temperature 210° C., zone 4 lower temperature 220° C., zone 5 upper temperature 260° C., zone 5 lower temperature 270° C. but remaining condition data are set commonly, the result data are represented to correlate with the reflow results (positional variation (standard deviation) 0.03 mm, temperature profile β). In this case, as for the temperature profile, temperature change data corresponding to the type (β, γ, or the like) of each temperature profile with a lapsed time are stored in the result table. In step S4, the result table formed in this manner is output from the CPU 2 to the internal memory device 6 and stored in the result table storing portion 61. In this case, the result table of the pre-step (i.e., the parts mounting step) is stored in the result table storing portion 61, but such table may be completely erased in step S4.

Meanwhile, in FIG. 11, the condition table is formed by inputting the process condition data of the reflowing step from the user in step S5. The process condition data have the same items as the condition data set in the result table. Then, in step S6, the process condition data are written into the condition table by the condition setting portion 23 and then stored in the condition table storing portion 62 of the internal memory device 6.

The process condition data input in step S5 and the calculated result data of the pre-step (i.e., the step P-2 and the step P-1) are written into the condition table of the reflowing step. As described above, in the simulation process of the solder printing step and the parts mounting step as the pre-step of the parts mounting step, in step S12, the solder printing results (solder size 0.55 mm*0.55 mm, thickness 0.125 mm, positional variation (standard deviation) 0.05 mm, viscosity 70 Pa·s, material SnAgCu) in the solder printing step and the parts conditions (parts size 0.5 mm*0.5 mm*0.4 mm, parts weight 0.1 g, positional variation (standard deviation) 0.1 mm) in the parts mounting step have already been written in the condition table as the pre-step calculated result data. Also, there are the items such as the reflow furnace conditions (zone temperature, carrying speed, etc.), and so on as the process condition data. For instance, the reflow furnace conditions (zone 1 upper temperature 185° C., zone 1 lower temperature 170° C., zone 2 upper temperature 170° C., zone 2 lower temperature 170° C., zone 3 upper temperature 175° C., zone 3 lower temperature 175° C., zone 4 upper temperature 210° C., zone 4 lower temperature 220° C., zone 5 upper temperature 260° C., zone 5 lower temperature 270° C., carrying speed 1.3 m/min) are newly written as the process condition data. In this case, the processing condition data of the pre-step (i.e., the parts mounting step) have already been described in the condition table storing portion 62 and such data may be totally erased in step S4. But it is preferable that such data should be stored continuously to display the conditions used in the simulation in the display process described later.

Then, in step S7, the sample calculating portion 24 of the CPU 2 executes the simulation operation by using the result table (see FIG. 10) and the condition table (see FIG. 11) of the reflowing step, and outputs the results as the calculated result data. The sample calculating portion 24 samples the result data corresponding to these data and set forth in the condition table as the calculated result data, based on the process condition data set forth in the condition table and the pre-step calculated result data. Since the condition data equivalent to the data set forth in the condition table shown in FIG. 11 are present in the result table shown in FIG. 10, the sample calculating portion 24 samples the result data associated with the condition data as the calculated result data in the reflowing step. In other words, the sample calculating portion 24 executes the simulation of the reflowing step containing the simulation process results in the pre-step, and samples the reflowing result (positional variation (standard deviation) 0.03 mm, temperature profile β) as the calculated result data. In addition, the sample calculating portion 24 also calculates predetermined items (e.g., the maximum temperature of the object parts 250° C., the maximum temperature duration time 4 sec, etc.) necessary for the display process described later as the calculated result data. In this case, it is needless to say that, if the data that coincide with the condition table are not contained in the condition data in the result table in the reflowing step, the sample calculating portion 24 calculates the data in vicinity of the above result data set forth in the result table as the calculated result data by executing the interpolation calculation, or the like.

In this fashion, since the mounting process simulation system 1 is able to simulate successively respective steps constituting the actual production processes by using the simulation results of the pre-step, degrees of influence of the initial design conditions, production conditions in respective steps, and production variations upon the overall production process can be evaluated in advance. For instance, as with final positional precision of parts with respect to the substrate, positional variation of the parts in the parts mounting step may be reduced because of the influence of the surface tension, etc. of the solder according to the positional variation in the solder printing step and the product conditions in the reflowing step. Also, the final positional precision is affected by a bump size and a solder printing thickness. In other words, degrees of influence indicating to what extent the soldering failure after the reflowing is subjected to the influence of design conditions of the parts position, etc. and control items of each step such as a thickness of a metal mask, a size of the opening portion, etc. must be evaluated. Since the mounting process simulation system 1 is able to simulate totally a degree of influence of each step beforehand every evaluation item respectively, the final result can be evaluated previously in response to the actual production. This leads to reductions in the fraction defective in each step and the fraction defective after the final step because the evaluation criterion of each step and the final evaluation criterion can be evaluated appropriately in answer to the actual production.

Returning to FIG. 3, as described above, in case the step P being calculated now in step S8 is the final step or in case the calculated result data in the step P being calculated now in step S9 are displayed on the display device 4, the CPU 2 advances the process to step S14 or step S10 respectively to execute the display process. The display processes in step S10 and step S14 will be explained hereunder.

In-step S10 or step S14, the sample calculating portion 24 of the CPU 2 executes the display process to display or print these data, by outputting via the animation translation processing portion 25 or directly the calculated result data, the pre-step calculated result data stored in the condition table storing portion 62, and the process condition data used in these operations to the display device 4. The animation translation processing portion 25 constructs the three-dimensional animation based on the above data being output from the sample calculating portion 24 and operation descriptions in the step as the process object defined by the individual step animation defining file 53, and then outputs the animation to the display device 4. Individual animation elements constituting the three-dimensional animation such as translation, deformation, etc. of the object are stored in advance in the basic display process library 52. The animation translation processing portion 25 constructs the animation corresponding to the above data by calling appropriately the animation elements stored in the basic display process library 52. The display device 4 presents the animation to the user by displaying or printing the animation indicating the above data being output from the animation translation processing portion 25. Also, in case the above data are output directly from the sample calculating portion 24, the display device 4 may display or print the calculated result data as they are as character images such as numerical values, etc.

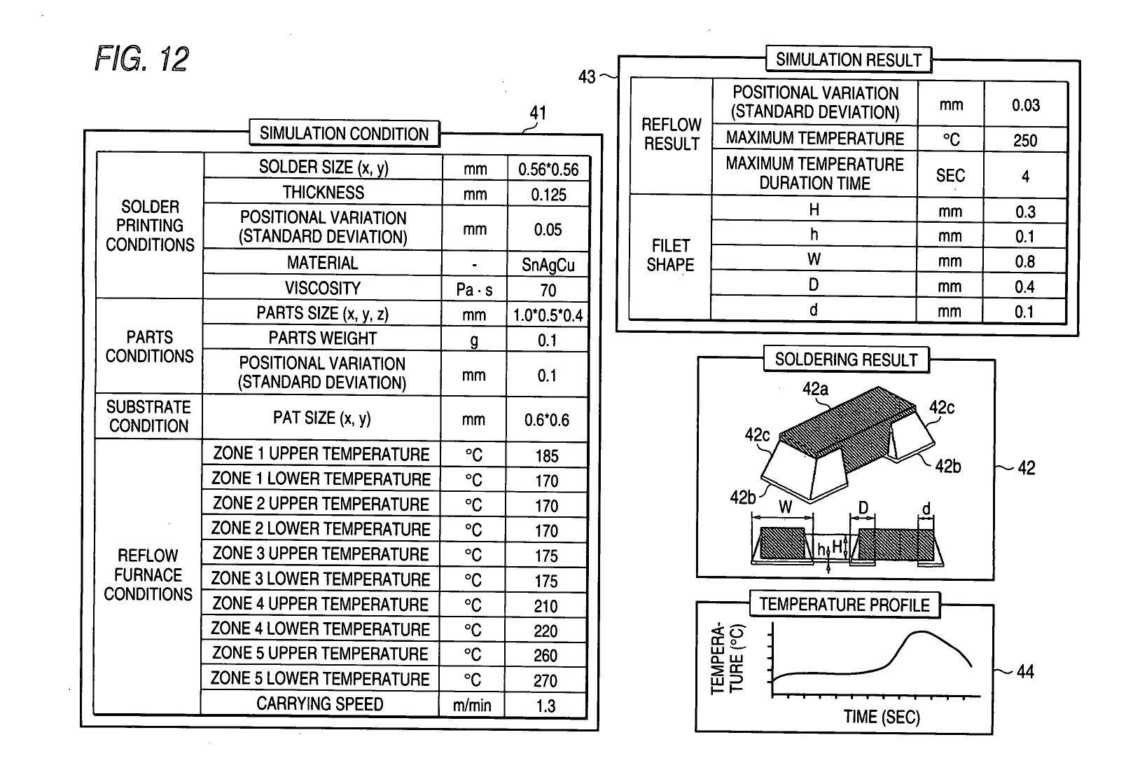

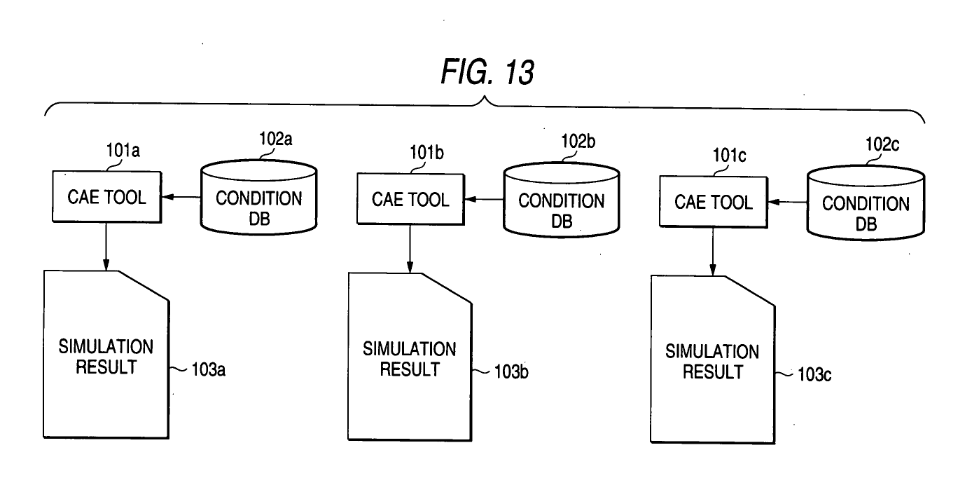

FIG. 12 is an example in which the display device 4 displays the animation indicating the above data output from the animation translation processing portion 25, in the above reflowing step. In FIG. 12, the data to be displayed on the display device 4 are displayed in respective display areas 41 to 44 in response to the type of the displayed data.

For example, the process condition data and the pre-step calculated result data in the condition table used in the simulation process in the step as the process object by the CPU 2 are displayed in the display area 41 as the character data of the simulation condition. In case the above reflowing step as the object is displayed in the display area 41, the data set forth in the condition table (see FIG. 11) used in the simulation process of the reflowing step are displayed. In other words, the solder printing results (solder size 0.55 mm*0.55 mm, thickness 0.125 mm, positional variation (standard deviation) 0.05 mm, viscosity 70 Pa·s, material SnAgCu) in the solder printing step, and the parts conditions (parts size 1.0 mm*0.5 mm*0.4 mm, parts weight 0.1 g, positional variation (standard deviation) 0.1 mm) in the parts mounting step are displayed as the pre-step calculated result data in the condition table. Also, the reflow furnace conditions (zone temperature, carrying speed, etc.), and so on as the process condition data. For instance, the reflow furnace conditions (zone 1 upper temperature 185° C., zone 1 lower temperature 170° C., zone 2 upper temperature 170° C., zone 2 lower temperature 170° C., zone 3 upper temperature 175° C., zone 3 lower temperature 175° C., zone 4 upper temperature 210° C., zone 4 lower temperature 220° C., zone 5 upper temperature 260° C., zone 5 lower temperature 270° C., carrying speed 1.3 m/min) are displayed as the process condition data in the condition table. In addition, the substrate conditions (pat size 0.6 mm*0.6 mm) used in the calculation of the solder printing step are displayed as the simulation process conditions. In this case, these data displayed in the display area 41 may set arbitrarily.

The soldering result is displayed in the display area 42 based on the operation description of the step as the process object to constitute the three-dimensional animation. As described above, the animation translation processing portion 25 outputs the operation of the step as the process object by using the individual step animation defining file 53, in which the operation sequences of individual steps are defined, based on the data being output from the sampling calculating portion 24. Individual animation elements constituting the three-dimensional animation such as translation, deformation, etc. of the object are stored in advance in the basic display process library 52. The animation translation processing portion 25 constructs the animation corresponding to the above calculated result data by calling appropriately the animation elements stored in the basic display process library 52 based on the individual step animation defining file 53. For example, as the result of the above simulation result, the soldering result is displayed as the animation. In this animation display, the soldering result of a parts and a substrate (pat) as the object of the simulation process is indicated, and a parts 42a, a pat 42b, and a solder 42c are displayed. A shape of the solder 42c is displayed as the animation based on dimensions of respective major portions of a fillet shape calculated by the simulation. The dimensions of respective major portions are a height H from a bottom surface of the parts 42a to an uppermost portion of the solder 42c, a height h from the bottom surface of the parts 42a to an upper surface of the pat 42b, sizes W and D of the solder 42c formed on the upper surface of the pat 42b, a size d of the solder 42c formed on the upper surface of the pat 42b on one end of the parts 42a, etc. These dimensions of respective major portions may be analyzed beforehand by the CAE tool 11, the mounting equipment 12, the inspecting equipment 13, or the experimenting equipment 14, and then put into the result table to contain the dimensions of the major portions upon forming the result table. Alternately, if the CPU 2 has the CAE function, such CPU 2 may calculate these dimensions of respective major portions by using respective data set forth in the condition table during the simulation process of the reflowing step. The animation translation processing portion 25 executes the animation display based on the dimensions of the major portions and the sizes and positional variations of the parts and the substrate (pat) serving as the objects of the simulation process. In this manner, in case the mounting process simulation system 1 represents behaviors of respective steps in terms of the animation, such system can deal easily with the animation presentation by sampling the common elements as the standard library.

In this case, these animations may be displayed as other simulation results, or may be displayed by using a three-dimensional viewing point translation, a sectional view, or a perspective view. For example, a deformation (bowing) of the substrate after the reflowing step may be displayed as the animation by the reflow furnace interior thermal analysis. In case intermediate steps such as the solder printing step, the parts mounting step, etc. are displayed as the animation, the user can monitor the solder printing shapes and interferences between the parts with the eye by displaying respective simulation results three-dimensionally. Also, operations of the equipment units such as the suction nozzle of the parts mounting device, etc. as well as the objective parts, the substrate, etc. may be displayed as the animation by using the animation elements of the equipment units stored in the basic display process library 52.

The calculated result data calculated in the step as the process object are displayed as character data of the simulation result in the display area 43. If the above reflowing step is displayed as the object in the display area 43, the calculated result data calculated in the simulation process of the reflowing step is displayed. More particularly, the reflow results (positional variation (standard deviation) 0.03 mm, temperature profile β, maximum temperature 250° C., maximum temperature duration time 4 sec) are displayed. In addition, dimensions of major portions in the above filet shape are also displayed. For example, a height H: 0.3 mm, a height h: 0.1 mm, a size W: 0.6 mm, a size D: 0.4 mm, a size d: 0.1 mm, etc. are displayed.

A temperature profile is displayed in the display area 44 based on the profile type calculated in the simulation process of the reflowing step. As this temperature profile, a temperature shift of the object parts is displayed on a graph having an axis of abscissa: time (sec) and an axis of ordinate: temperature (° C.).

The CPU 2 advances the process to step S11 when the above display process is carried out in step S10, while the CPU 2 ends the process in compliance with the flowchart when the above display process is carried out in step S14.

In this way, according to the mounting process simulation system 1, since respective steps in the mounting operation are simulated successively, it is possible to check in advance how the overall mounting process is influenced by the initial design conditions and the production conditions in respective steps, and therefore appropriate design of the circuit substrate and appropriate development of the engineering method can be implemented. Also, it is made easy to sample important management items and their proper values in the manufacturing site. In addition, since the simulation results can be virtually displayed as the three-dimensional animation, the real visual monitoring can be facilitated.

In this case, the mounting process simulation system is explained above while taking the reflow soldering process as an example. But the mounting process simulation system of the present invention can execute the simulation process of other manufacturing steps. For example, the mounting process simulation system of the present invention can be applied to the adhesive coating step that is added in the course of the above reflow soldering process, or can be applied to simulation processes in various manufacturing steps such as semiconductor manufacturing steps composed of bump forming step, adhesive transferring/IC mounting process, sealing step, etc., and so forth.

Also, the above simulation results can be utilized in the reliability evaluation such as a life prediction of the circuit substrate that is subjected to the simulation. For example, if the reliability of the circuit substrate and performances of the high frequency characteristic, etc. are evaluated by looking up various databases containing experimental or analysis data based on solder composition, shape of solder jointed portion, amount of solder, etc. contained in the simulation result, the reliability evaluation can be simulated beforehand.

Also, if the above simulation result is evaluated on the basis of the evaluation criteria set on respective steps by using the calculated result data calculated in respective steps, the fraction defective in respective steps can be calculated beforehand. In addition, since the evaluation criteria of respective steps with respect to the final evaluation criterion of the final product, or the like can be evaluated appropriately in response to the actual production, an increase of the yield and a reduction of the fraction defective can be easily attained. Further, since the simulation result and the evaluation result of the fraction defective can be fed back to the substrate design, these results can be easily connected to design correction of the circuit substrate.

Also, the above simulation result can be used to verify the testing performance of the testing step provided in the mounting production step. For example, as with positions of plural parts mounted on the circuit substrate in a narrowly adjacent condition and positions of the parts in the multi-layered substrate, it is feasible to verify beforehand in what manner (e.g., laser measurement or X-ray inspection) the intervals or the positions should be tested.

Also, an example in which the mounting process simulation system 1 is constructed by a single computer system is explained above. In this case, the mounting process simulation system 1 may be attached to the mounting equipments provided to correspond to respective simulated steps, and may be provided separately respectively. In this case, only the external memory device 5 is provided in common, and a set of the CPU 2, the input device 3, the display device 4 and the internal memory device 6 are attached to the mounting equipments respectively. Then, each CPU 2 is connected to the CPUs 2 provided to the preceding step and the succeeding step via a predetermined communication device to transmit/receive the data, so then the condition table containing the calculated result data being calculated in each own step is output to the CPU 2 in the succeeding step. Accordingly, the mounting process simulation system provided to the mounting equipment in each step can execute the same simulation as above by using the condition table in the pre-step. Then, the mounting process simulation system provided every mounting equipment can be utilized easily during the production. For example, when the production conditions are changed, manufacturing precision of own step and the influence on the post-step can be easily verified. Also, when a tendency that is different from the simulation result is recognized such as the case where the fraction defective in own step is worsened, etc., the simulation can be executed immediately once again by using the resultant data of the mounting equipment to verify the cause.

In this manner, since respective steps in the mounting operation are simulated successively, it is possible to check in advance how the overall mounting process is influenced by the initial design conditions and the production conditions in respective steps, and therefore appropriate design of the circuit substrate and appropriate development of the engineering method can be implemented. Also, it is made easy to sample important management items and their proper values in the manufacturing site. In addition, since the simulation results can be virtually displayed as the three-dimensional animation, the real visual monitoring can be facilitated.

The present invention is not limited to the embodiments and the description thereof at all. If various changes which can be easily conceived by those skilled in the art are not departed from the description of the scope of claim, they may be contained in the present invention.

What is claimed is:

1. A mounting process simulation program of causing a computer to execute a simulation of a mounting process composed of a plurality of steps, the program causing the computer to execute:
a first simulation executing step of executing a simulation based on a first condition selected for a first step;
a simulation condition deciding step of deciding a result simulated in the first simulation executing step as a simulation condition for a second step positioned subsequent to the first step; and
a second simulation executing step of executing a simulation-of the second step based on a second condition containing at least the simulation condition.

2. A mounting process simulation program according to claim 1, wherein analysis result data simulated previously based on a plurality of conditions are generated every step, and
the second simulation executing step executes the simulation of the second step by sampling the analysis result data simulated based on the second condition.

3. A mounting process simulation program according to claim 1, wherein analysis result data simulated previously based on a plurality of conditions are generated every step, and
the second simulation executing step executes the simulation of the second step by executing an interpolation calculation using the analysis result data simulated based on a preceding or succeeding condition of the second condition.

4. A mounting process simulation program according to claim 2 or 3, wherein the analysis result data are generated by other device provided to an outside of the computer, and
the second simulation executing step executes the simulation of the second step by converting the analysis result data generated by other device into a predetermined data format.

5. A mounting process simulation program according to claim 4, wherein at least one of data simulated previously every step by using a CAE tool, mounting resultant data of a mounting equipment provided to a mounting site every step, and experimental data derived by an experiment in which an operation in each step is supposed is selected as the analysis result data.

6. A mounting process simulation program according to claim 1, further causing the computer to execute an animation displaying step of displaying three-dimensionally an animation to indicate a result simulated in the second simulation executing step on a display device, by reading previously- stored animation elements based on a definition file in which an operation sequence is defined every step.

7. A mounting process simulation program according to claim 1, wherein the second simulation executing step includes a condition acquiring step of reading a condition selected in response to an input from a condition database in which a plurality of conditions are stored previously in combination, and adding the condition to the second condition.

8. A mounting process simulation program according to claim 7, wherein the condition acquiring step further reads data from a CAD system in response to the input and adds the data to the second condition.

9. A mounting process simulation program according to claim 1, wherein the first simulation executing step executes the simulation to contain production variation in the first step,
the simulation condition deciding step decides the result simulated in the first simulation executing step to contain the production variation as the simulation condition, and
the second simulation executing step executes the simulation of the second step based on the second condition to contain the production variation.

10. A mounting process simulation program according to claim 1, wherein the first simulation executing step executes the simulation based on a change of a control item set in the first step as the first condition,
the simulation condition deciding step decides the result simulated based on the change of the control item in the first simulation executing step as the simulation condition, and
the second simulation executing step executes the simulation of the second step based on the second condition to contain the result simulated based on at least the change of the control item.

11. A mounting process simulation program according to claim 1, further causing the computer to execute
a reliability evaluating step of executing a reliability evaluation of a product manufactured in the mounting process by using the result simulated in the second simulation executing step.

12. A mounting process simulation program according to claim 1, further causing the computer to execute
a fraction defective calculating step of calculating a fraction defective of a product manufactured in the first step and the second step, by using results simulated in the first simulation executing step and the second simulation executing step.

13. A mounting process simulation system provided to steps of a mounting process composed of a plurality of steps to execute a simulation of the mounting process, comprising:
an inputting portion for inputting a condition to execute the simulation;
an executing portion for executing the simulation based on the condition input from the inputting portion; and
an outputting portion for outputting a result of the simulation executed by the executing portion;
wherein the executing portion includes:
a condition table forming portion forming a condition table that lists a simulation condition, which is formed by using a simulation result simulated based on a first condition selected for at least a first step, of a second step positioned subsequently to a first step, and
a simulation result outputting portion executes the simulation of the second step based on the condition table and a condition input from the inputting portion and outputs a result to the outputting portion.

14. A mounting process simulation method of executing a simulation of a mounting process composed of a plurality of steps, comprising:
a first simulation executing step of executing a simulation based on a first condition selected for a first step;
a simulation condition deciding step of deciding a result simulated in the first simulation executing step as a simulation condition for a second step positioned subsequent to the first step; and
a second simulation executing step of executing a simulation of the second step based on a second condition containing at least the simulation condition.
